(19) United States
(12) Patent Application Publication
(10) Pub. No.: US 2008/0292389 A1
(43) Pub. Date: Nov. 27, 2008

(54) Fixing and Release Through Location Sensing

(75) Inventor: Dickory Rudduck, Chicago, IL (US)

Correspondence Address: TELEZYGOLOGY, INC., 520 W. ERIE STREET, SUITE 210, CHICAGO, IL, 60654, US

(73) Assignee: Telezygology, Inc., Chicago, IL (US)

(21) Appl. No.: 11/914,707

(22) PCT Filed: May 18, 2006
(86) PCT No.: PCT/AU2006/000653

§ 371 Date: Jul. 7, 2008

(30) Foreign Application Priority Data
May 18, 2005 (AU) AU2005902523
May 19, 2005 (AU) AU2005902565

(51) Int. Cl. F16B 1/00

(52) U.S. Cl. 403/27

(57) ABSTRACT

The invention relates to a fastening system (16) including a fastener having a locking means, actuating means adapted to cause the locking means to engage or disengage, and means for sensing a location. The invention further relates to a method for operating a fastening system. The method including the steps of providing a fastener having a locking means, providing actuating means for causing the locking means to engage or disengage, sensing a location, and actuating the actuating means to cause the locking means to engage or disengage.

### FIELD OF THE INVENTION

This invention relates to fasteners. In particular, this invention relates to a fastening system and a method for operating a fastening system, in both cases involving sensing of location.

### BACKGROUND OF THE INVENTION

Various types of fasteners, fastening systems and fastener assemblies have been disclosed in earlier patent applications, especially international patent applications No PCT/AU99/00185 “Fixing and Release System”, PCT/AU03/00759 “Further Improvements in Fixing and Release System”, PCT/AU03/01539 “Bolt Assembly”, PCT/AU2004/000371 “Fastener for Airbags and other Uses” and PCT/AU2004/001580 “Fasteners and Other Assemblies”. The content of each of these patent specifications is imported herein by reference.

In many cases, the fasteners disclosed in the above specifications can be locked and/or unlocked remotely or by hard wiring. The present invention is concerned with operating a fastener through sensing of location of or by the fastener.

### DISCLOSURE OF THE INVENTION

Accordingly, this invention provides a fastening system including:
a fastener including a locking means;
actuating means adapted to cause the locking means to engage or disengage; and
means for sensing a location.

The invention also provides a method for operating a fastening system, the method including the steps of:
providing a fastener having a locking means;
providing actuating means for causing the locking means to engage or disengage;
sensing a location; and
actuating the actuating means to cause the locking means to engage or disengage.

In this system and method of the invention, the locking means may be any appropriate locking means, including appropriate choices from the specifications referred to above and imported herein by reference. For example, in connection with the fastener illustrated in FIG. 40 of PCT/AU99/00185, the locking means is expanded portions 117 and 118, while the actuating means is locking pin 112. By way of further example, in PCT/AU03/00759, the locking means is engagement wedge 14 (refer FIGS. 1 to 3) while the actuating means is shape memory alloy wire 18.

With reference to PCT/AU2004/001580, in FIGS. 5 to 7 the locking means is pin 48 and the actuating means is wire 40. In the same specification, in the embodiment in FIGS. 8A to 8G, the locking means is pin 152 and the actuating means is wire 162. In the embodiment in FIGS. 17 to 21, the locking means is pin 182 and the actuating means is the shape memory alloy wire which causes rotation of shuttle 192. With regard to the embodiment in FIGS. 52 to 55, the locking means is engagement means 612 and the actuating means is smart memory alloy wire 642. In the embodiment in FIG. 56, the locking means is rod 654 and the actuating means is shape memory alloy wire 642.

The above are some examples only of the types of locking means and actuating means which are included within the scope of the present invention.

The means for sensing the location may be of many different types.

By way of example, the location sensing means may be incorporated in the fastener. The fastener may detect its correct position or location. Detection of the location may cause actuation of the fastener, so that the tongue locks into the aperture. The fastener of this embodiment may include means for sensing the correct position, for example a reader sensitive to information identifying the correct position. As an example, the correct position may be identified by a unique bar code and the fastener may include a bar code reader.

The fastener referred to as a “beam” fastener in PCT/AU2004/001580 may be used, for example.

Other non-limiting examples are set out below.

The location may be physically indexed, for example by having a hole, dent or bump on, for example, a track. The physical index may convey a digital code. The sensing means in this case may be a microswitch sensor. This example is relatively simple and inexpensive.

The location may be marked by an optical bar code and the sensor may comprise or include a reader for reading the bar code, as mentioned above. This example is relatively simple and inexpensive and moreover is readily moisture sealed, as is the previous example.

The location may be marked by binary coded magnetic elements, and the sensing means may include or comprise a reader. This example is inherently robust as well as being readily moisture sealable.

As an alternative to the previous example, the location may be magnetically indexed with incremental indexing. Thus binary coded magnetic elements may be located on, for example, a track at relatively widely spaced intervals with incremental magnetic markers between binary coded locations. The sensing means may be capable of reading these, for example, by counting a set number of incremental points to establish the final location. This example is both inherently robust and readily moisture sealable.

The location may be marked by a short range transponding tag, such as a short range inductively coupled passive radio frequency identification tag which may be embedded at the location. The sensing means may include means for interrogating the tag. This example is inherently robust and readily moisture sealable.

If the location is on an electrically coupled track, the location may be marked by a pulse or correlation based position measurement of distance, relative to a reference connection point. The sensing means may transmit a pulse to the reference device, which retransmits the pulse for reception and transit time measurement by a receiving unit. Alternately, a continuously-transmitting correlation technique could perform this function. Effectively, this arrangement is similar to one-dimensional radar. This is regarded as a potentially elegant solution, because, where a track is involved, no specific treatment to the track is required, as long as a continuous bus fed power or data means is implemented.

The location may be sensed by a laser transponder, to determine location relative to a fixed target. This uses standard, simple technology.

In a similar example, the sensing means may include an ultrasonic transponder to determine location relative to a fixed transponder. This also is standard and simple technology.

The sensing means may include a radio transponder which can determine location relative to a fixed transponder. Like the two previous examples, this is standard and simple technology.

The sensing means is not restricted to the examples set out above.

Where a power feed is required for the location, this may be effected by any suitable means, including cables, buses, etc.

The location may be established in, for example, two dimensions or three dimensions instead of one dimension. In such an embodiment, the fastening system may include means for sensing a location along x and y coordinates and optionally may report on position of the fastener in relation to the location to be sensed. Thus an item may be moved into position for fastening, even though the fastener or the location for fastening may not be visible. Similarly, the location may be established along x, y and z coordinates.

The fastening system of the invention may form part of, for example, an object to be fixed to or released from a track. If the object is to be fixed to the track at a particular location, the object in this example is caused to move along the track until the sensing means senses a chosen proximity to the location, at which stage the actuating means is actuated to cause the locking means to lock the object into the track. The object may be a seat, or a light fitting for example. Many other applications are possible. Further examples are a window in a window frame, in which the window can be locked in any one of several sensed positions, shelving or racks in a carcase, in which each shelf or rack may be locked into any one of several sensed positions, and a pipe or similar object which is to be mounted by being locked to part of a building or other assembly. The invention in this embodiment can be particularly useful when the object needs to be manoeuvred without any or complete visibility of the place to which the object is to be fixed.

The locking means may be caused to engage or disengage when the location is sensed. However, the invention is not limited to this. Sensing of the location may prevent engagement of the locking means, if the particular location sensed is not intended for engagement by a particular object. For example, the invention may be applied to a chess board, where, as is known, various chess pieces are restricted as to the way in which they may be moved by a player. A knight piece, for instance, may only move in a combination of one square in a “straight” direction and one square in a “diagonal” direction. After sensing of a pre-move location of a knight piece, any attempt to move that piece to a position not permitted by the rules may prevent engagement of the knight piece with the board in the illegal position. This may be of great assistance in educating players in chess moves.

### BRIEF DESCRIPTION OF THE DRAWINGS

The invention will now be described in connection with certain non-limiting embodiments thereof, in connection with the accompanying drawings.

In the drawings:

FIG. 1 is a side elevation of a track containing three moveable light assemblies;

FIG. 2 is an enlarged, perspective view of one of the moveable light assemblies in the track of FIG. 1;

FIG. 3 is an elevation of a Window assembly having a fixed pane and a moveable pane within a window frame, showing the fully closed position;

FIG. 4 shows the window assembly of FIG. 3, with the moveable pane in the half-open position;

FIG. 5 shows the window assembly of FIGS. 3 and 4, with the moveable pane in the fully open position;

FIG. 6 is an enlarged view of the window assembly of FIGS. 3 to 5, showing the moveable pane in a track in the window frame;

FIG. 7 is a perspective view of a carcase containing a plurality of relocatable shelves, the carcase being partly broken away;

FIG. 8 is a perspective view from below of one of the shelves in the carcase of FIG. 7;

FIG. 9 is an elevation of part of a pipe suspended from a building;

FIG. 10 shows the pipe of FIG. 9 in a perspective view from below;

FIG. 11 is a plan view of a chess board showing, in diagrammatic form, a single chess piece; and

FIG. 12 is a perspective view of part of a chess board of FIG. 11.

### DETAILED DESCRIPTION OF THE DRAWINGS

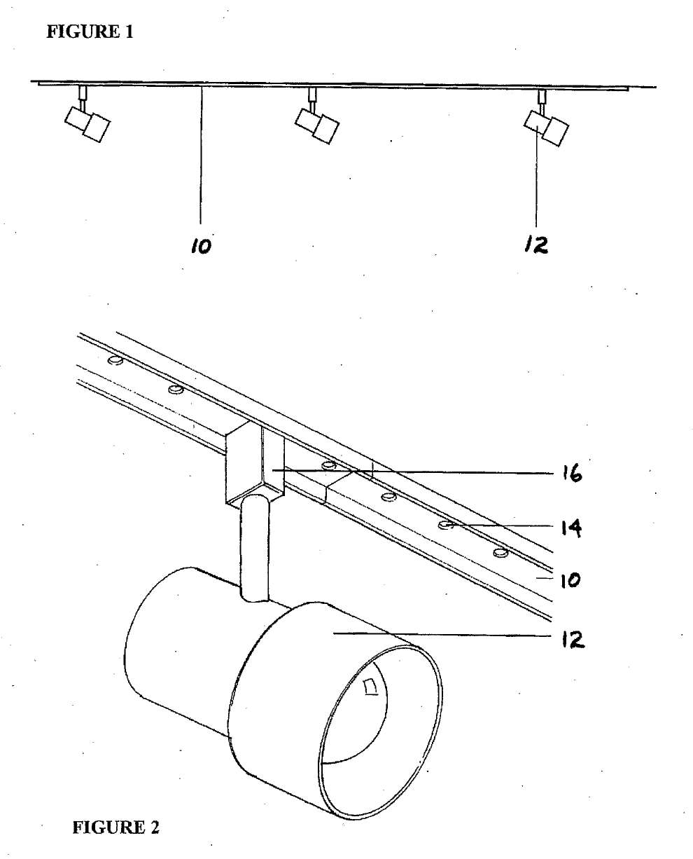

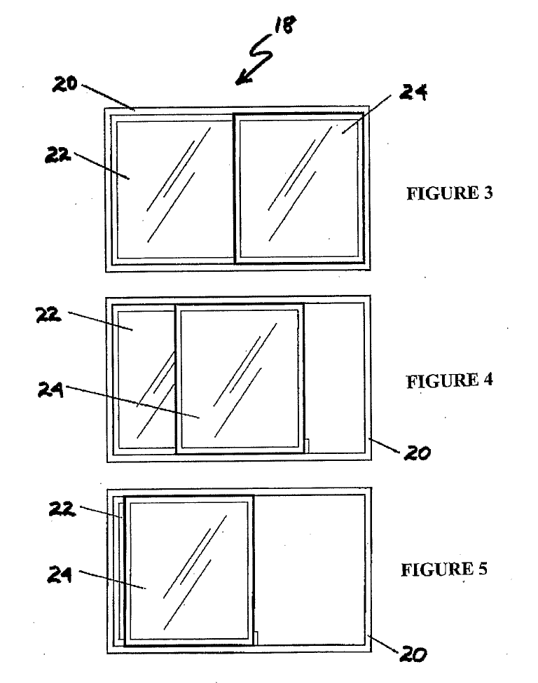

Reference is made first to FIGS. 1 and 2. In these Figures, track 10 is shown having mounted therein three moveable light assemblies 12. Incorporated in track 10 are several positioning holes 14. Concealed in the base 16 of each light assembly 12 is an intelligent fastener assembly having a locking means, actuating means adapted to cause the locking means to engage or disengage and means for sensing any or a selected one or few of holes 14.

The intelligent fastener assembly in base 16 may be designed to sense any of holes 14 and lock into that hole as soon as base 16 is properly lined up. Alternately, an intelligent fastener assembly in one base 16 may be programmed so that it may lock light assembly 12 into only one or only a few of positioning holes 14. This may be desirable, for example, so that light assemblies 12 may be properly spaced along track 10.

The intelligent fastening system in base 16 may be any suitable fastening system, including those already discussed above. The location sensing means may also be chosen from any suitable means discussed above.

Each of light assemblies 12 may be disengaged from the appropriate positioning hole 14 by any suitable method, such as by remote activation, discussed in connection with the specifications imported herein by reference.

Reference is now made to the embodiment in FIGS. 3 to 6. In these Figures, window assembly 18 has a frame 20, a fixed pane 22 and a slidable pane 24. In this embodiment, slidable pane 24 is designed so that it may be locked in the fully closed position, as in FIG. 3, in the partly open position, as in FIG. 4 or in the fully open position, as in FIG. 5.

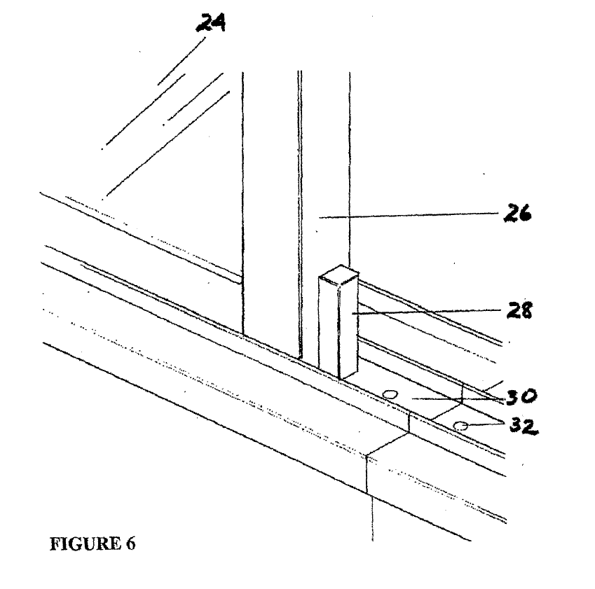

In the detail shown in FIG. 6, slidable pane 24 has sash 26 attached to which is intelligent fastener assembly 28. Once again, the actual fastener included in intelligent fastener assembly 28 may be any suitable fastener, including those discussed above.

Window frame 20 includes horizontal track 30 which has a series of positioning holes 32. Positioning holes 32 may be spaced evenly along track 30 or only three may be provided, to enable slidable pane 24 to be fixed in any of the positions shown in FIGS. 3, 4 and 5.

Slidable pane 24 may be fixed, via intelligent fastener assembly 28, in any suitable hole 32, as described above in connection with the embodiment in FIGS. 1 and 2.

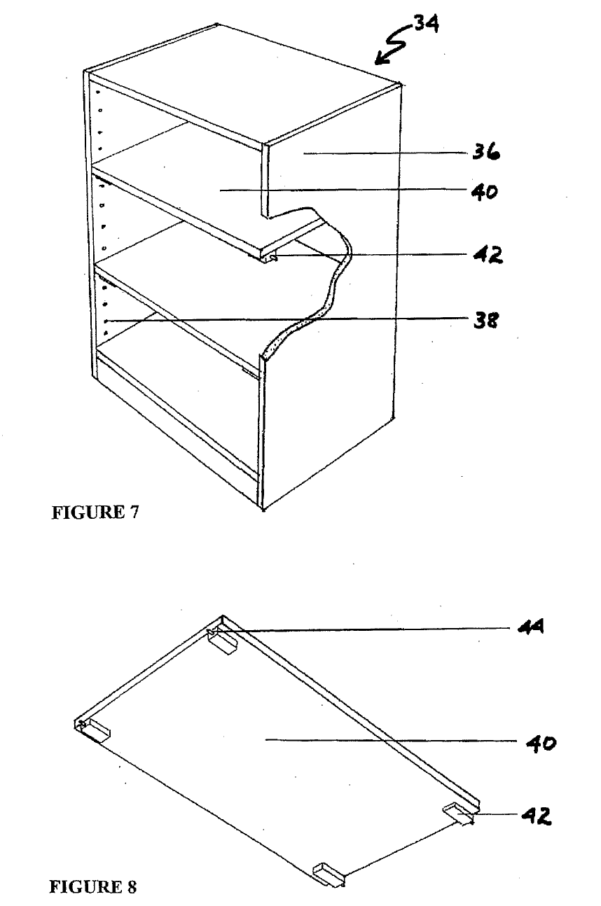

The next embodiment is shown in FIGS. 7 and 8. Cabinet 34 has carcase 36 in which are formed several positioning holes 38. A plurality of shelves 40 are provided. Each shelf 40 has at or near each corner an intelligent fastener assembly 42, chosen from any suitable fastener assembly, including those described above. Each fastener assembly 42 includes location sensing means which can sense location of holes 38 in two dimensions within carcase 36. Thus each fastener assembly 42, once shelf 40 is pushed into rough position within carcase 36, can sense and, if desired, report on whether shelf 40 is pushed in sufficiently into 55 carcase 36 and whether shelf 40 needs to be raised or lowered so as to insert fastener pin 44 into the appropriate hole 38. This embodiment is an example of two dimensional location sensing.

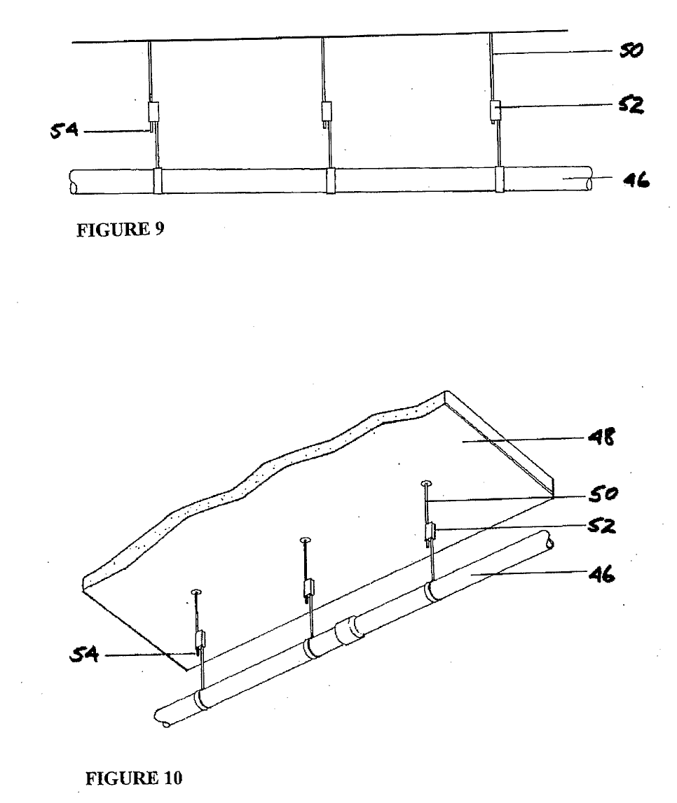

An example of three dimensional location sensing is shown in FIGS. 9 and 10. In this embodiment, pipe 46 is to be suspended from ceiling 48 by hanging components 50, to which intelligent fastener assemblies 52 are to be attached.

When manoeuvring pipe 46 into position beneath ceiling 48, each intelligent fastener assembly 52 may sense end 54 of hanging component 50 and report on whether the intelligent fastener assembly 52, and hence pipe 46 to which it is attached, needs to be lined up in any or all of three dimensions in order to mate with intelligent fastener assembly 52. A report to this effect may be generated to assist the manoeuvring of pipe 46.

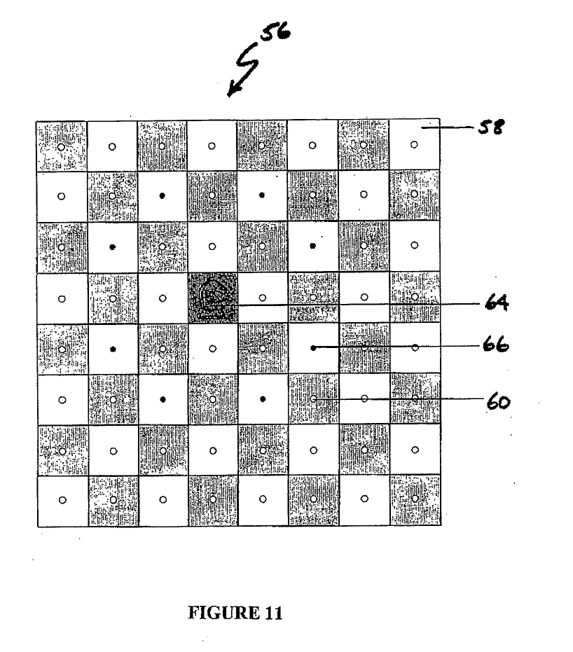

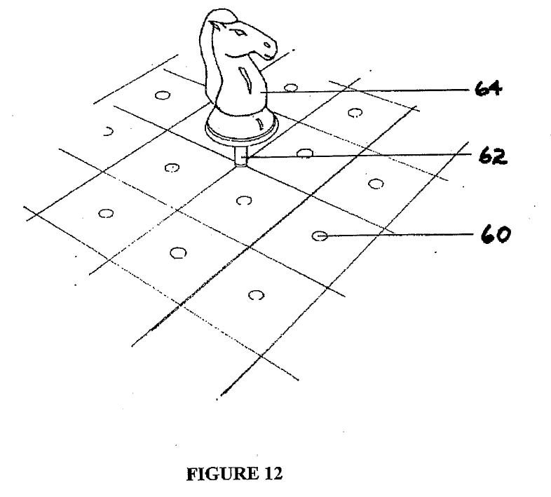

FIGS. 11 and 12 show chess board 56, in which each playing square 58 includes a socket 60. An intelligent fastener 62 is attached to the base of each playing piece. In FIGS. 9 and 10, the playing piece is a knight, but the invention may be adapted to any other type of playing piece. Because the knight is restricted as to the type of moves it can make, intelligent fastener 62 may be programmed, in the case of knight 64, to permit knight 64 to be attached to only certain locations. These are shown as open (black) sockets 66 in FIG. 11 since each of these represents a permissable move location for knight 64. Intelligent fastener 62 may be programmed so that knight 64 may not be attached to any of the other closed (white) sockets shown in FIG. 11, in the move contemplated in FIG. 11.

### INDUSTRIAL APPLICABILITY

As will be readily appreciated by those skilled in the various arts, the invention disclosed herein is not limited to the examples set out and has wide applications in many areas, representing significant advances in the relevant art. In particular, the invention provides a fastening system and a method for operating a fastening system, in both cases involving sensing of location, which are far more sophisticated compared to prior art systems, permitting the application of modern technology.

1. A fastening system including:
a fastener including a locking means;
actuating means adapted to cause the locking means to engage or disengage; and
means for sensing a location.

2. The fastening system of claim 1, wherein the location is adapted to be physically indexed having a hole, dent or bump on a track.

3. The fastening system of claim 1, wherein the location is adapted to be marked by an optical bar code.

4. The fastening system of claim 1, wherein the location is adapted to be marked by binary coded magnetic elements.

5. The fastening system of claim 1, wherein the location is adapted to be magnetically indexed with incremental indexing, such that binary coded elements are adapted to be located at relatively widely spaced intervals with incremental magnetic markers.

6. The fastening system of claim 1, wherein the location is adapted to be marked by a short range transponding tag.

7. The fastening system of claim 1, wherein the location is adapted to be on an electrically coupled track and marked by a pulse or correlation based position measurement of distance, relative to a reference connection point.

8. The fastening system of claim 1, wherein the location is adapted to be established in two or three dimensions.

9. The fastening system of claim 1, wherein the sensing means is chosen from: a microswitch sensors a bar code reader, means capable of reading incremental magnetic markers by counting a set number of incremental points to establish the location, means capable of interrogating a short range transponding tag, means capable of transmitting a pulse to a reference device which retransmits the pulse for reception and transits time measurement by a receiving unit, a laser transponder, an ultrasonic transponder, and a radio transponder.

10. A method for operating a fastening system, the method including the steps of:
providing a fastener having a locking means;
providing actuating means for causing the locking means to engage or disengage;
sensing a location; and
actuating the actuating means to cause the locking means to engage or disengage.

11. The method of claim 10, wherein the location is adapted to be physically indexed having a hole, dent or bump on a track.

12. The method of claim 10, wherein the location is adapted to be marked by an optical bar code.

13. The method of claim 10, wherein the location is adapted to be marked by binary coded magnetic elements.

14. The method of claim 10, wherein the location is adapted to be magnetically indexed with incremental indexing, such that binary coded elements are adapted to be located at relatively widely spaced intervals with incremental magnetic markers.

15. The method of claim 10, wherein the location is adapted to be marked by a short range transponding tag.

16. The method of claim 10, wherein the location is adapted to be on an electrically coupled track and marked by a pulse or correlation based position measurement of distance, relative to a reference connection point.

17. The method of claim 10, wherein the location is adapted to be established in two or three dimensions.

18. The method of claim 10, wherein the sensing means is chosen from: a microswitch sensor, a bar code reader, means capable of reading incremental magnetic markers by counting a set number of incremental points to establish the location, means capable of interrogating a short range transponding tag, means capable of transmitting a pulse to a reference device which retransmits the pulse for reception and transits time measurement by a receiving unit, a laser transponder, an ultrasonic transponder, and a radio transponder.

19. The fastening system of claim 1, which is adapted to form part of an object to be fixed to or released from a track, wherein if the object is to be fixed to the track at a particular location, the object is adapted to be caused to move along the track until the sensing means senses a chosen proximity to the location, at which stage the actuating means is actuated to cause the locking means to lock the object into the track.

20. The fastening system of claim 19, wherein the object is a seat, a light fitting or a window pane.

21. The fastening system of claim 1, which is adapted to form part of a first object to be fixed to or released from a second object.

22. The fastening system of claim 21, wherein the location sensing means is adapted to sense the location in two or three dimensions.

23. (canceled)

24. (canceled)
